(19) United States
(12) Patent Application Publication
(10) Pub. No.: US 2018/0157991 A1
(43) Pub. Date: Jun. 7, 2018

(54) APPARATUS AND METHOD FOR EVALUATING COMPLEXITY OF CLASSIFICATION TASK

(71) Applicant: FUJITSU LIMITED, Kawasaki-shi (JP)

(72) Inventors: Song WANG, Beijing (CN); Li SUN, Beijing (CN); Wei FAN, Beijing (CN); Jun SUN, Beijing (CN)

(73) Assignee: FUJITSU LIMITED, Kawasaki-shi (JP)

(21) Appl. No.: 15/799,352

(22) Filed: Oct. 31, 2017

(30) Foreign Application Priority Data
Dec. 1, 2016 (CN) 201611095611.4

(51) Int. Cl. G06N 99/00; G06N 7/00

(52) U.S. Cl. CPC G06N 99/005; G06N 7/00

(57) ABSTRACT

An apparatus and a method for evaluating complexity of a classification task are provided. The apparatus includes: one or more processing circuits, configured to calculate, with respect to each sample of at least a part of training samples for the classification task, similarities between the sample and respective classes, respectively; and calculate, based on the similarities, a task complexity score for the classification task.

### CROSS-REFERENCE TO RELATED APPLICATIONS

The present application claims priority to Chinese Patent Application No. 201611095611.4, entitled “APPARATUS AND METHOD FOR EVALUATING COMPLEXITY OF CLASSIFICATION TASK”, filed on Dec. 1, 2016 with the State Intellectual Property Office of People's Republic of China, which is incorporated herein by reference in its entirety.

### BACKGROUND

### 1. Field

The embodiments of the present disclosure relates to the field of information processing, in particular to the field of machine learning, and more particularly, to an apparatus and a method for evaluating complexity of a classification task.

### 2. Description of the Related Art

Classification problems are often encountered in the field of machine learning. Various classifiers such as a deep neural network, SVM, and a Gaussian mixture model may be selected for solving the classification problems. However, in practical applications, an appropriate classifier needs to be selected with respect to a classification task. Complexity of the classifier being much higher than that of the classification task leads to serious over fitting and a waste of computing resources. On the contrary, the complexity of the classifier being lower than that of the classification task results in a poor classification result. Therefore, it is necessary to select an appropriate classifier according to the complexity of the classification task.

### SUMMARY

In the following, an overview of the embodiments is given simply to provide basic understanding to some aspects of the present embodiments. It should be understood that this overview is not an exhaustive overview of the present embodiments. It is not intended to determine a critical part or an important part of the present embodiments, nor to limit the scope of the present embodiments. An object of the overview is only to give some concepts in a simplified manner, which serves as a preface of a more detailed description described later.

According to an aspect of the present disclosure, an apparatus for evaluating complexity of a classification task is provided, which includes: a similarity calculating unit, configured to calculate, with respect to each sample of at least a part of training samples for the classification task, similarities between the sample and respective classes, respectively; and a score calculating unit, configured to calculate, based on the similarities, a complexity score for the classification task.

According to another aspect of the present disclosure, a method for evaluating complexity of a classification task is provided, which includes: calculating, with respect to each sample of at least a part of training samples for the classification task, similarities between the sample and respective classes, respectively; and calculating, based on the similarities, a complexity score for the classification task.

According to another aspect of the present disclosure, an apparatus for evaluating complexity of a classification task is further provided, which includes one or more processing circuits configured to: calculate, with respect to each sample of at least a part of training samples for the classification task, similarities between the sample and respective classes, respectively; and calculate, based on the similarities, a complexity score for the classification task.

According to other aspects of the present disclosure, corresponding computer program code, computer-readable storage medium, and a computer program product are also provided.

With the apparatus and the method according to the present disclosure, similarities between a training sample and respective classes are calculated, and complexity of a classification task is evaluated using the similarities. In this way, the complexity of the classification task can be accurately evaluated, thereby providing a basis for selecting a classifier.

These and other advantages of the present disclosure will be more apparent by illustrating in detail a preferred embodiment in conjunction with accompanying drawings below.

### BRIEF DESCRIPTION OF THE DRAWINGS

To further set forth the above and other advantages and features of the embodiments, detailed description will be made in the following taken in conjunction with accompanying drawings in which identical or like reference signs designate identical or like components. The accompanying drawings, together with the detailed description below, are incorporated into and form a part of the specification. It should be noted that the accompanying drawings only illustrate, by way of example, typical embodiments and should not be construed as a limitation to the scope thereof. In the accompanying drawings:

FIG. 1 is a block diagram showing a structure of an apparatus for evaluating complexity of a classification task according to an embodiment of the present disclosure;

FIG. 2 is a block diagram showing a structure of a similarity calculating unit according to an embodiment of the present disclosure;

FIG. 3 is a flowchart showing a method for evaluating complexity of a classification task according to an embodiment of the present disclosure;

FIG. 4 is a flowchart showing sub steps of step S11 in FIG. 3; and

FIG. 5 is an exemplary block diagram illustrating the structure of a general purpose personal computer capable of realizing the method and/or device and/or system according to the embodiments.

### DETAILED DESCRIPTION

Reference will now be made in detail to the embodiments, examples of which are illustrated in the accompanying drawings, wherein like reference numerals refer to the like elements throughout. The embodiments are described below by referring to the figures.

An exemplary embodiment will be described hereinafter in conjunction with the accompanying drawings. For the purpose of conciseness and clarity, not all features of an embodiment are described in this specification. However, it should be understood that multiple decisions specific to the embodiment have to be made in a process of developing any such embodiment to realize a particular object of a developer, for example, conforming to those constraints related to a system and a business, and these constraints may change as the embodiments differs. Furthermore, it should also be understood that although the development work may be very complicated and time-consuming, for those skilled in the art benefiting from the present disclosure, such development work is only a routine task.

Here, it should also be noted that in order to avoid obscuring the embodiments due to unnecessary details, only a device structure and/or processing steps closely related to the solution according to the embodiments are illustrated in the accompanying drawing, and other details having little relationship to the embodiments are omitted.

The following description hereinafter are provided in the following order:
1. Apparatus for evaluating complexity of a classification task
2. Method for evaluating complexity of a classification task
3. Computing device for implementing an apparatus and a method according to the present disclosure

### [1. Apparatus for Evaluating Complexity of a Classification Task]

As described above, it is quite important to take complexity of a classification task into consideration when selecting a classifier in terms of improving the accuracy and efficiency of the classification. Therefore, it is desired to accurately evaluate the complexity of the classification task.

A block diagram showing a structure of an apparatus 100 for evaluating complexity of a classification task is provided according to this embodiment. The apparatus 100 includes: a similarity calculating unit 101, configured to calculate, with respect to each sample of at least a part of training samples for the classification task, similarities between the sample and respective classes, respectively; and a score calculating unit 102, configured to calculate, based on the similarities, a complexity score for the classification task.

The similarity calculating unit 101 and the score calculating unit 102 may be implemented, for example, by one or more processing circuits which may be implemented as a chip/chips.

The apparatus 100 calculates the complexity of the classification task using at least a part of the training samples for the classification task. Moreover, the complexity is represented by a complexity score, so that the complexity of the classification task can be accurately measured in the form of digits.

Specifically, the similarity calculating unit 101 may calculate the similarities between the sample and respective classes in various manners. For example, the similarity calculating unit 101 may perform classification on the training samples using a relatively simple classifier, and obtain the similarities based on a result of the classification.

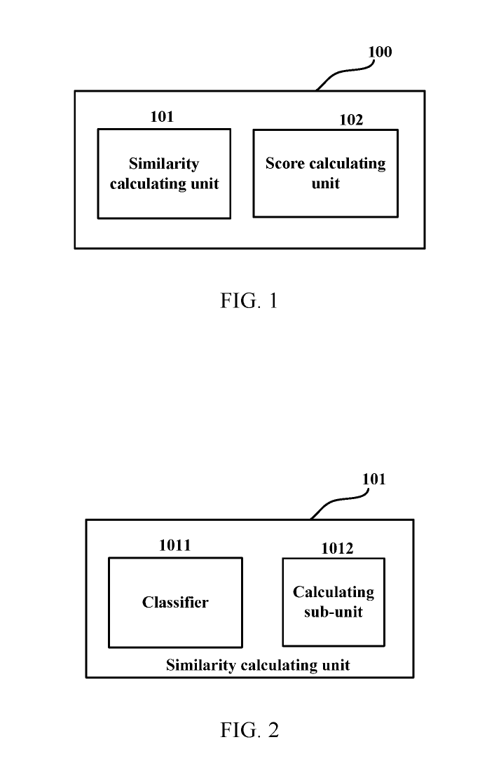

As shown in FIG. 2, in an example, the similarity calculating unit 101 may include: a classifier 1011, configured to perform classification on the at least a part of training samples; and a calculating sub-unit 1012, configured to calculate the similarities based on a result of the classification. The classifier 1011 may be, for example, a Gaussian mixture model, a convolutional neural network, a support vector machine, a simple center classifier or the like.

Specifically, the classifier 1011 may be trained based on the above-described at least a part of training samples in the case that the classifier 1011 needs to be obtained by training. After the training is completed, these training samples are classified using the obtained classifier 1011.

It is to be noted that, before classifying the samples using the classifier 1011 or before training the classifier 1011, it may be necessary to preprocess the samples. For example, each sample is converted into a representation vector, and all the representation vectors have the same dimension. For example, in a case of classifying images, one feature vector may be extracted for a whole image as the representation vector, and the feature vector may be, for example, a speeded up robust feature (SURF), a scale invariant feature transform (SIFT) or the like.

Next, an operation of the similarity calculating unit 101 is described by taking the simple center classifier as an example of the classifier 1011. In the case of using the simple center classifier, it is unnecessary to perform training in advance, and the calculating sub-unit 1012 calculates a distance between each sample and a center of each class as a similarity between the sample and the class, where the distance may be a Euclidean distance, for example.

For example, it is assumed that the classification task has n classes and a training samples in total. First, the center of the class is calculated, for example, the center of the class is an average vector of the representation vectors of the samples in the class. In a case of calculating the center vector of an i-th class, assuming that there are m samples in the i-th class, the center vector Cᵢ is calculated from the following equation (1):

$${C}_{i} = \frac{1}{m} {\sum }_{k = 1}^{m} {s}_{k} , \qquad ( 1 )$$

where sₖ is a representation vector of a sample in the i-th class. As can be seen, center vectors of all the classes may be calculated from the equation (1).

Then, for example, a distance dⱼ from a sample sₖ to a j-th class may be calculated, for example, from the following equation (2), where the distance is a measure of the similarity between the sample and the j-th class:

$${d}_{j} = \frac{{e}^{- ‖ {s}_{k} - {C}_{j} ‖}}{{\sum }_{i = 1}^{n} {e}^{- ‖ {s}_{k} - {C}_{i} ‖}} . \qquad ( 2 )$$

It should be understood that, the simple center classifier is merely an example, and other classifiers may also be used for calculating the similarity. For example, in a case of using the convolutional neural network, similarities between a sample and respective classes may be obtained during classification. In this case, the similarity is not represented by the Euclidean distance as shown in equation (2).

After the similarity calculating unit 101 calculates the similarities between the sample and respective classes as described above, the score calculating unit 102 calculates a complexity score for the classification task based on the similarities.

In an example, the score calculating unit 102 is configured to calculate, based on the similarities, a second similarity representing similarities between each sample and classes to which the sample does not belong, and calculate the complexity score based on the second similarity and a similarity between each sample and a class to which the sample belongs.

In the example, regardless of the classes included in the classification task, the classification task is converted into a binary classification problem that is a classification problem regarding whether or not an item belongs to a certain class. When calculating the complexity score for a sample, the score calculating unit 102 needs to consider both the similarity between the sample and the class to which it belongs and the similarity between the sample and the class to which it does not belong. Accordingly, the technology of the embodiment may be applied to a classification task containing any number of classes, and thus the technology of the embodiment has wide applicability.

For example, the second similarity may be a maximum value of similarities between the sample and the classes to which the sample does not belong. Taking the similarities obtained using the simple center classifier as an example, the score calculating unit 102 may calculate the complexity score pₖ for a sample sₖ in the j-th class from the following equation (3):

$${p}_{k} = \frac{{d}_{j}}{{d}_{j} + max ( {d}_{i} , i \neq j )} . \qquad ( 3 )$$

Alternatively, the second similarity may be an average value of similarities between the sample and the classes to which the sample does not belong. Taking the similarities obtained using the simple center simplifier as an example, the score calculating unit 102 may calculate the complexity score pₖ for the sample sₖ in the j-th class from the following equation (4):

$${p}_{k} = \frac{{d}_{j}}{{d}_{j} + avg ( {d}_{i} , i \neq j )} . \qquad ( 4 )$$

After the complexity scores for respective samples are calculated, the score calculating unit 102 calculates the complexity score for the classification task based on the complexity scores. In an example, the score calculating unit 102 acquires the complexity score for the classification task by taking a weighted average of the complexity scores of the respective samples, as expressed by the following equation (5):

$$P = \frac{1}{a} {\sum }_{k = 1}^{a} {p}_{k } \times {w}_{k} , \qquad ( 5 )$$

where wₖ is a weight corresponding to the sample sₖ, and

$${\sum }_{k = 1}^{a} {w}_{k} = 1.$$

wₖ is used to adjust a degree of importance of each sample and may be set in various manners. For example, for all the samples in each class, wₖ may be set to be the same, and may be adjusted based on the number of samples included in the class. Further, for example, in a case of classifying images, wₖ of each sample may be adjusted based on the number of black pixels, and the like.

In subsequent selection of a classifier, an appropriate classifier may be selected based on the complexity score P calculated by the score calculating unit. A selection performed based on P can be very accurate since the complexity score P is a quantized value.

In summary, the apparatus 100 according to the embodiment can calculate a complexity score for a classification task accurately, thereby providing basis for selecting a classifier.

### [2. Method for Evaluating Complexity of a Classification Task]

In the process of describing the apparatus for evaluating complexity of a classification task in the embodiments described above, obviously, some processing and methods are also disclosed. Hereinafter, an overview of the methods is given without repeating some details disclosed above. However, it should be noted that, although the methods are disclosed in a process of describing the apparatus for evaluating complexity of a classification task, the methods do not certainly employ or are not certainly executed by the aforementioned components. For example, the embodiments of the apparatus for evaluating complexity of a classification task may be partially or completely implemented with hardware and/or firmware, the method described below may be executed by a computer-executable program completely, although the hardware and/or firmware of the apparatus for evaluating complexity of a classification task can also be used in the methods.

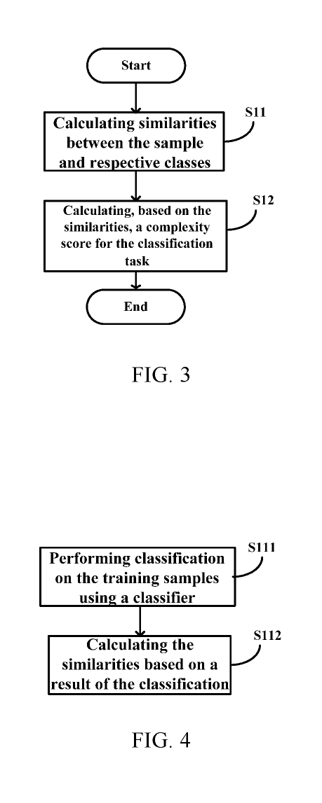

FIG. 3 shows a flowchart of a method for evaluating complexity of a classification task according to an embodiment of the present disclosure. The method includes: calculating, with respect to each sample of at least a part of training samples for the classification task, similarities between the sample and respective classes, respectively (S11); and calculating, based on the similarities, a complexity score for the classification task (S12).

As shown in FIG. 4, step S11 may include the following sub-steps: performing classification on the at least a part of training samples using a classifier (S111); and calculating the similarities based on a result of classification (S112). Specifically, the classifier may be a simple center classifier, a convolutional neural network, a Gaussian mixture model or the like.

A distance between each sample and each class center is calculated as a similarity between the sample and the class in step S112 in a case that the classifier is a simple center classifier. The classifier may be obtained based on the at least a part of training samples in a case that the classifier needs to be trained.

In an example, in step S12, a second similarity representing similarities between each sample and classes to which the sample does not belong is calculated based on the similarities, and the complexity score is calculated based on the second similarity and a similarity between each sample and a class to which the sample belongs.

For example, the second similarity may be a maximum value of the similarities between the sample and the classes to which the sample does not belong. Alternatively, the second similarity may be an average value of the similarities between the sample and the classes to which the sample does not belong.

In step S12, a complexity score for each sample is calculated, and the complexity score for the classification task is obtained by taking a weighted average of the complexity scores of the respective samples. A weight of a complexity score for each sample may be set in various manners. For example, the weights may be adjusted based on the number of samples included in each class.

With the method according to the embodiment, the complexity score for a classification task may be calculated accurately, thereby providing a basis for selecting a classifier.

The relevant details in the above embodiment have been given in detail in the description of the apparatus for evaluating complexity of a classification task, and will not be repeated herein.

### [3. Computing Device for Implementing an Apparatus and a Method According to the Present Disclosure]

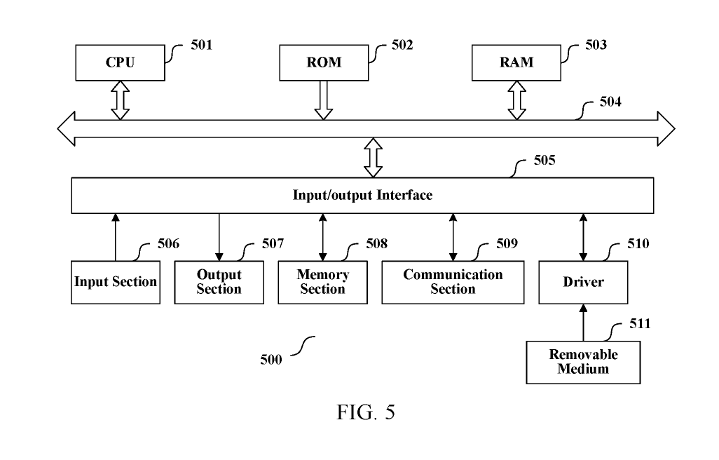

Each of constituent modules and/or units of the above-described apparatus may be configured as software, firmware, hardware, or a combination thereof. The specific means or manner in which the configuration may be used is well known to those skilled in the art and will not be described herein. In the case where the present disclosure is realized by software or firmware, a program constituting the software is installed in a computer with a dedicated hardware structure (e.g. the general computer 500 shown in FIG. 5) from a storage medium or network, where the computer is capable of implementing various functions when installed with various programs.

In FIG. 5, a central processing unit (CPU) 501 executes various processing based on a program stored in a read-only memory (ROM) 502 or a program loaded to a random access memory (RAM) 503 from a memory section 508. The data needed for the various processing of the CPU 501 may be stored in the RAM 503 as needed. The CPU 501, the ROM 502 and the RAM 503 are linked with each other via a bus 504. An input/output interface 505 is also linked to the bus 504.

The following components are linked to the input/output interface 505: an input section 506 (including keyboard, mouse and the like), an output section 507 (including displays such as a cathode ray tube (CRT), a liquid crystal display (LCD), a loudspeaker and the like), a memory section 508 (including hard disc and the like), and a communication section 509 (including a network interface card such as a LAN card, modem and the like). The communication section 509 performs communication processing via a network such as the Internet. A driver 510 may also be linked to the input/output interface 505. If needed, a removable medium 511, for example, a magnetic disc, an optical disc, a magnetic optical disc, a semiconductor memory and the like, may be installed in the driver 510, so that the computer program read therefrom is installed in the memory section 508 as appropriate.

In the case where the foregoing series of processing is achieved by software, programs forming the software are installed from a network such as the Internet or a memory medium such as the removable medium 511.

It should be appreciated by those skilled in the art that the memory medium is not limited to the removable medium 511 shown in FIG. 5, which has program stored therein and is distributed separately from the apparatus so as to provide the programs to users. The removable medium 511 may be, for example, a magnetic disc (including floppy disc (registered trademark)), a compact disc (including compact disc read-only memory (CD-ROM) and digital versatile disc (DVD), a magneto optical disc (including mini disc (MD)(registered trademark)), and a semiconductor memory. Alternatively, the memory medium may be the hard discs included in ROM 502 and the memory section 508 in which programs are stored, and can be distributed to users along with the device in which they are incorporated.

The present disclosure further discloses a program product in which machine-readable instruction codes are stored. The aforementioned methods according to the embodiments can be implemented when the instruction codes are read and executed by a machine.

Accordingly, a memory medium, such as a non-transitory computer readable storage medium, for carrying the program product in which machine-readable instruction codes are stored is also covered in the present disclosure. The memory medium includes but is not limited to soft disc, optical disc, magnetic optical disc, memory card, memory stick and the like.

Finally, it is to be further noted that, the term “include”, “comprise” or any variant thereof is intended to encompass nonexclusive inclusion so that a process, method, article or device including a series of elements includes not only those elements but also other elements which have been not listed definitely or an element(s) inherent to the process, method, article or device. Moreover, the expression “comprising a(n) . . . ” in which an element is defined will not preclude presence of an additional identical element(s) in a process, method, article or device comprising the defined element(s) unless further defined.

Although the embodiments of the present disclosure have been described above in detail in connection with the drawings, it shall be appreciated that the embodiments as described above are merely illustrative but not limitative of the disclosure. Those skilled in the art can make various modifications and variations to the above embodiments without departing from the spirit and scope of the present disclosure. Therefore, the scope of the present disclosure is defined merely by the appended claims and their equivalents.

By way of the foregoing description, embodiments of the present disclosure provide the following technical solutions, but are not limited thereto.

Appendix 1. An apparatus for evaluating complexity of a classification task, comprising:

a similarity calculating unit, configured to calculate, with respect to each sample of at least a part of training samples for the classification task, similarities between the sample and respective classes, respectively; and

a score calculating unit, configured to calculate, based on the similarities, a complexity score for the classification task.

Appendix 2. The apparatus according to Appendix 1, wherein the score calculating unit is configured to calculate, based on the similarities, a second similarity representing similarities between each sample and classes to which the sample does not belong, and calculate the complexity score based on the second similarity and a similarity between each sample and a class to which the sample belongs.

Appendix 3. The apparatus according to Appendix 2, wherein the second similarity is a maximum value of the similarities between the sample and the classes to which the sample does not belong.

Appendix 4. The apparatus according to Appendix 2, wherein the second similarity is an average value of the similarities between the sample and the classes to which the sample does not belong.

Appendix 5. The apparatus according to Appendix 1, wherein the score calculating unit is configured to calculate a complexity score for each sample, and acquire the complexity score for the classification task by taking a weighted average of the complexity scores of the samples.

Appendix 6. The apparatus according to Appendix 5, wherein the score calculating unit is configured to adjust weights based on the number of samples included in each of the classes.

Appendix 7. The apparatus according to Appendix 1, wherein the similarity calculating unit comprises:

a classifier, configured to perform classification on the at least a part of training samples; and

a calculating sub-unit, configured to calculate the similarities based on a result of the classification.

Appendix 8. The apparatus according to Appendix 7, wherein the classifier is a simple center classifier, and the calculating sub-unit is configured to calculate a distance between each sample and a center of each of the classes as the similarity between the sample and the class.

Appendix 9. The apparatus according to Appendix 7, wherein the classifier is further configured to be trained based on the at least a part of training samples.

Appendix 10. A method for evaluating complexity of a classification task, comprising:

calculating, with respect to each sample of at least a part of training samples for the classification task, similarities between the sample and respective classes, respectively; and

calculating, based on the similarities, a complexity score for the classification task.

Appendix 11. The method according to Appendix 10, wherein calculating, based on the similarities, a complexity score for the classification task comprises: calculating, based on the similarities, a second similarity representing similarities between each sample and classes to which the sample does not belong, and calculating the complexity score based on the second similarity and a similarity between each sample and a class to which the sample belongs.

Appendix 12. The method according to Appendix 11, wherein the second similarity is a maximum value of the similarities between the sample and the classes to which the sample does not belong.

Appendix 13. The method according to Appendix 11, wherein the second similarity is an average value of the similarities between the sample and the classes to which the sample does not belong.

Appendix 14. The method according to Appendix 10, wherein the calculating, based on the similarities, a complexity score for the classification task comprises: calculating a complexity score for each sample, and acquiring the complexity score for the classification task by taking a weighted average of the complexity scores of the samples.

Appendix 15. The method according to Appendix 14, wherein weights are adjusted based on the number of samples included in each of the classes.

Appendix 16. The method according to Appendix 10, wherein calculating similarities between each sample and each class comprises:

performing classification on the at least a part of training samples; and

calculating the similarities based on a result of the classification.

Appendix 17. The method according to Appendix 16, wherein the classifier is a simple center classifier, and calculating the similarities comprises calculating a distance between each sample and a center of each of the classes as the similarity between the sample and the class.

Appendix 18. The method according to Appendix 16, wherein the classifier is further configured to be trained based on the at least a part of training samples.

Although a few embodiments have been shown and described, it would be appreciated by those skilled in the art that changes may be made in these embodiments without departing from the principles and spirit thereof, the scope of which is defined in the claims and their equivalents.

What is claimed is:

1. An apparatus for evaluating complexity of a classification task, comprising:
one or more processing circuits, configured to
calculate, with respect to each sample of at least a part of training samples for the classification task, similarities between the sample and respective classes, respectively; and
calculate, based on the similarities, a task complexity score for the classification task.

2. The apparatus according to claim 1, wherein the one or more processing circuits is further configured to calculate, based on the similarities, a second similarity representing similarities between each sample and classes to which the sample does not belong, and calculate the task complexity score based on the second similarity and another similarity between each sample and a class to which the sample belongs.

3. The apparatus according to claim 2, wherein the second similarity is a maximum value of the similarities between the sample and the classes to which the sample does not belong.

4. The apparatus according to claim 2, wherein the second similarity is an average value of the similarities between the sample and the classes to which the sample does not belong.

5. The apparatus according to claim 1, wherein the one or more processing circuits is further configured to calculate a sample complexity score for each sample, and acquire the task complexity score for the classification task by taking a weighted average of sample complexity scores of the samples.

6. The apparatus according to claim 5, wherein the one or more processing circuits is further configured to adjust weights based on a number of samples that are included in each of the classes.

7. The apparatus according to claim 1, wherein the one or more processing circuits is further configured to:
perform classification, with a classifier, on the at least a part of training samples; and
calculate the similarities based on a result of classification.

8. The apparatus according to claim 7, wherein the classifier is a simple center classifier, and the one or more processing circuits is configured to calculate a distance between each sample and a center of each of the classes as the similarity between the sample and the class.

9. The apparatus according to claim 7, wherein the classifier is further configured to be trained based on the at least a part of training samples.

10. A method for evaluating complexity of a classification task, comprising:
calculating, with respect to each sample of at least a part of training samples for the classification task, similarities between the sample and respective classes, respectively; and
calculating, based on the similarities, a task complexity score for the classification task.

11. The method according to claim 10, wherein calculating, based on the similarities, the task complexity score for the classification task comprises: calculating, based on the similarities, a second similarity representing similarities between each sample and classes to which the sample does not belong, and calculating the task complexity score based on the second similarity and another similarity between each sample and a class to which the sample belongs.

12. The method according to claim 11, wherein the second similarity is a maximum value of the similarities between the sample and the classes to which the sample does not belong.

13. The method according to claim 11, wherein the second similarity is an average value of the similarities between the sample and the classes to which the sample does not belong.

14. The method according to claim 10, wherein the calculating, based on the similarities, the task complexity score for the classification task comprises: calculating a sample complexity score for each sample, and acquiring the task complexity score for the classification task by taking a weighted average of the sample complexity scores of the samples.

15. The method according to claim 14, wherein weights are adjusted based on a number of samples that are included in each of the classes.

16. The method according to claim 10, wherein calculating similarities between each sample and each class comprises:
performing classification, with a classifier, on the at least a part of training samples; and
calculating the similarities based on a result of classification.

17. The method according to claim 16, wherein the classifier is a simple center classifier, and calculating the similarities comprises calculating a distance between each sample and a center of each of the classes as the similarity between the sample and the class.

18. The method according to claim 16, wherein the classifier is further configured to be trained based on the at least a part of training samples.

19. A non-transitory computer readable storage medium storing a method for controlling a computer according to claim 10.
